(19) United States
(12) Patent Application Publication
(10) Pub. No.: US 2023/0188984 A1
(43) Pub. Date: Jun. 15, 2023

(54) WIRELESS COMMUNICATION DEVICE, COMMUNICATION CONTROL METHOD, AND NON-TRANSITORY COMPUTER READABLE STORAGE MEDIUM

(71) Applicant: Yamaha Corporation, Hamamatsu-shi (JP)

(72) Inventors: Shuntaro SUZUKI, Shizuoka-shi (JP); Hirokazu SUZUKI, Yokohama-shi (JP)

(21) Appl. No.: 18/076,805

(22) Filed: Dec. 7, 2022

(30) Foreign Application Priority Data
Dec. 15, 2021 (JP) 2021-203459

(51) Int. Cl. H04W 12/06; H04W 12/61

(52) U.S. Cl. CPC H04W 12/06; H04W 12/61

(57) ABSTRACT

A wireless communication device includes a processor; and a memory configured to store a program, the program being executed by the processor to cause the processor to: change a RADIUS reauthentication interval used by a RADIUS server based on a number of RADIUS reauthentication failures for each of a plurality of communication terminals connected to the wireless communication device, and a first threshold.

### CROSS REFERENCE TO RELATED APPLICATIONS

This application claims the benefit of priority to Japanese Patent Application No. 2021-203459, filed on Dec. 15, 2021, the entire contents of which are incorporated herein by reference.

### FIELD

The present disclosure relates to a wireless communication device, a communication control method, and a non-transitory computer readable storage medium.

### BACKGROUND

Conventionally, there are communication systems that require reauthentication to connect a communication terminal to the network. In such a communication system, in order to manage authentication information of a communication terminal, authentication of a communication terminal is periodically performed by an authentication server connected to a network device such as an access point. For example, IEEE (Institute of Electrical and Electronics Engineers) 802.1X of the network device is authenticated. RADIUS (Remote Authentication Dial-in User Service) authentication is used as a method of authentication. A RADIUS server is used as a RADIUS authentication server. It is disclosed in Japanese laid-open patent publication No. 2006-197462 that the communication status is monitored, and the RADIUS reauthentication process is started only when the communication status is good during the execution of a real-time application, thereby preventing degradation.

### SUMMARY

According to an embodiment of the present disclosure, there is provided a wireless communication device, comprising: a processor; and a memory configured to store a program, the program being executable by the processor to cause the processor to: change a Remote Authentication Dial-in User Service (RADIUS) reauthentication interval used by the wireless communication device functioning as a RADIUS server based on: (i) a number of RADIUS reauthentication failures for a first communication terminal among a plurality of communication terminals connected to the wireless communication device, and (ii) a first threshold.

According to an embodiment of the present disclosure, there is provided a communication control method performed by a wireless communication device, the communication control method comprising: changing a Remote Authentication Dial-in User Service (RADIUS) reauthentication interval used by the wireless communication device functioning as a RADIUS server based on: (i) a number of RADIUS reauthentication failures for a first communication terminal among a plurality of communication terminals connected to the wireless communication device, and (ii) a first threshold.

According to an embodiment of the present disclosure, there is provided a non-transitory computer readable storage medium storing a program for causing a computer to: change a Remote Authentication Dial-in User Service (RADIUS) reauthentication interval used by a wireless communication device functioning as a RADIUS server based on: (i) a number of RADIUS reauthentication failures for a first communication terminal among a plurality of communication terminals connected to the wireless communication device, and (ii) a first threshold.

### BRIEF DESCRITION OF DRAWINGS

FIG. 1 is a diagram illustrating a configuration of a communication system according to a first embodiment of the present disclosure.

FIG. 2 is a flowchart illustrating a communication control process according to the first embodiment of the present disclosure.

FIG. 3 is a flowchart illustrating an initialization process according to the first embodiment of the present disclosure.

FIG. 4 is a diagram illustrating a setting process of a RADIUS reauthentication interval according to the first embodiment of the present disclosure.

FIG. 5 is a diagram illustrating a data table of a RADIUS reauthentication result according to the first embodiment of the present disclosure.

FIG. 6 is a diagram illustrating a data table of the number of RADIUS reauthentication failures according to the first embodiment of the present disclosure.

FIG. 7 is a diagram illustrating a data table of the number of RADIUS reauthentication failures according to the first embodiment of the present disclosure.

FIG. 8 is a flowchart illustrating a RADIUS reauthentication interval change process according to the first embodiment of the present disclosure.

FIG. 9 is a flowchart illustrating a changing process of a RADIUS reauthentication interval according to a second embodiment of the present disclosure.

FIG. 10 is a flowchart illustrating a changing process of a RADIUS reauthentication interval according to a third embodiment of the present disclosure.

FIG. 11 is a diagram illustrating a setting process of a RADIUS reauthentication interval according to a fourth embodiment of the present disclosure.

FIG. 12 is a diagram illustrating a configuration of a communication system according to a fifth embodiment of the present disclosure.

FIG. 13 is a flowchart illustrating an initialization process according to a sixth embodiment of the present disclosure.

### DESCRIPTION OF EMBODIMENTS

Hereinafter, a communication system according to an embodiment of the present disclosure will be described in detail with reference to the drawings. The following embodiments are examples of embodiments of the present disclosure, and the present disclosure is not to be construed as being limited to these embodiments. Also, in the drawings referred to in the present embodiments, the same portions or portions having similar functions are denoted by the identical symbols or similar symbols (symbols each formed simply by adding A, B, etc. to the end of a number), and a repetitive description thereof may be omitted.

If RADIUS reauthentication performed periodically fails, the network communication of a communication terminal is disconnected. If RADIUS reauthentication failures occur frequently, it may lead to network communication trouble. On the other hand, if a RADIUS reauthentication interval is lengthened, it is difficult to maintain a network-security environment. Therefore, it is assumed that a user himself/herself changes the RADIUS reauthentication interval. However, the user does not have sufficient knowledge on what conditions are required to determine the change the RADIUS reauthentication interval.

One of the objectives of the present disclosure is to easily set up an appropriate RADIUS reauthentication interval.

### First Embodiment

### 1-1. Overall Configuration of Communication System

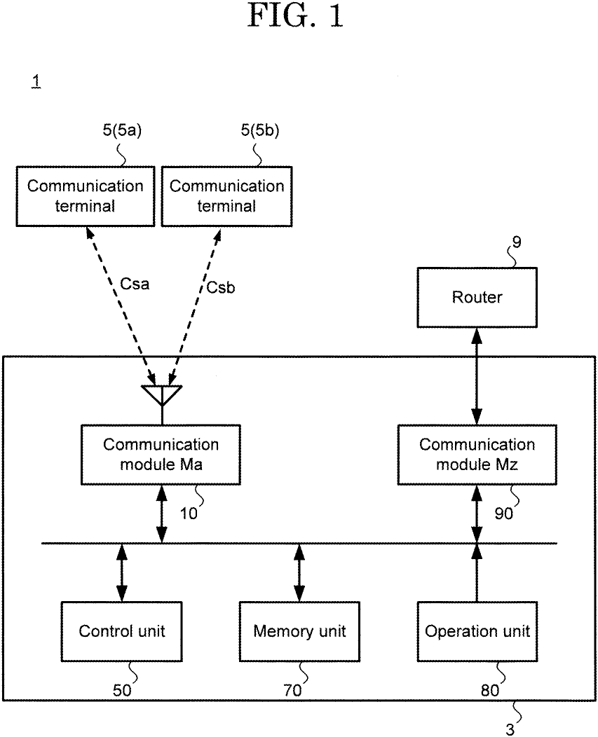

FIG. 1 is a diagram illustrating a configuration of a communication system 1. The communication system 1 includes an access point 3, a communication terminal 5, and a router 9. The communication system 1 according to the present embodiment is realized by the access point 3 that relays wireless communication. The access point 3 is capable of executing a process corresponding to a RADIUS authentication function. The access point 3 can easily set a RADIUS reauthentication interval according to the usage environment of the user and perform wireless communication by the methods described below. Hereinafter, an access point according to the present embodiment will be described.

### 1-2. Configuration of Access Point

The access point 3 is a device that provides a wireless LAN (Local Area Network) environment to a plurality of communication terminals 5 and is a device that relays the communication terminal 5 to a WAN (Wide Area Network) such as the Internet via the router 9. The access point 3 is also referred to as a wireless communication device. In FIG. 1, although two communication terminals 5 (a communication terminal 5a and a communication terminal 5b) are shown, the present disclosure is not limited thereto. In the communication device 1, only one communication terminal may be arranged, or three or more communication terminals may be arranged.

The access point 3 includes a communication module Ma10, a control unit 50, a memory unit 70, an operation unit 80, and a communication module Mz90. These configurations are connected by a bus.

The communication module Ma10 performs wireless communication (in this case, wireless communications Csa, Csb) with the communication terminal 5 using a channel set by the control unit 50 among the 5 GHz band channels. The channel set in the communication module Ma10 is selected from the channels included in the types W52, W53, and W56 in the IEEE802.11 standard. Also, the communication module Ma10 is not limited to the channels in the 5 GHz band, and channels in the 2.4 GHz band may be used.

In this example, the communication module Mz90 has the function as a communication unit for communicating with the router 9 and communicating with other devices via the router 9. This communication may be, for example, wireless using the 2.4 GHz band or 5 GHz band or may be wired.

The memory unit 70 stores a control program executed by the control unit 50, various tables, and the like. For example, the memory unit 70 stores a data table including date and time information, which will be described later, and a RADIUS reauthentication result at a certain date and time. The operation unit 80 includes an operating element such as a power button and a setting button, accepts a user’s operation on the operating element, and outputs a signal corresponding to the operation to the control unit 50.

The control unit 50 includes a calculation processing circuit, such as a CPU, and a memory. The control unit 50 executes the control program stored in the memory unit 70 by the CPU to realize various functions at the access point 3. The realized functions include a communication control function. According to this communication control function, it is possible to execute a process (hereinafter, referred to as a communication control process) to be described later.

In addition, in the present embodiment, the control unit 50 among the access point 3 has a function as a RADIUS server and a RADIUS client as the communication control functions. The RADIUS server function is a function for determining whether to authenticate (permit or deny) the connection of the connected communication terminal 5 to the network. The RADIUS client function is a function that requests RADIUS authentication from the RADIUS server according to a connection request from the communication terminal 5. If the RADIUS authentication by the RADIUS server is successful, the communication terminal 5 may communicate with the other communication terminal 5 arranged in the network and the server connected to the network. On the other hand, if the RADIUS authentication by the RADIUS server fails, the communication terminal 5 cannot communicate with the other communication terminal 5 arranged in the network and the server connected to the network.

The control program may be executed by a computer and may be provided in a state of being stored in a computer-readable recording medium such as a magnetic recording medium, an optical recording medium, a magneto-optical recording medium, or a semiconductor memory. In this case, the access point 3 may be provided with a device for reading the recording medium. In addition, the control program may be downloaded via the communication module. Next, the communication control process (communication control method) will be described.

### 1-3. Communication Control Process

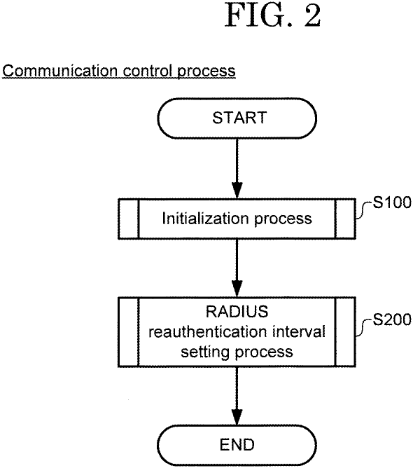

The communication control process is started by turning on the power at the access point 3. Also, the communication control process may be started by a request (start setting) for starting the communication control process from the user. FIG. 2 is a flowchart illustrating a communication control process according to the first embodiment of the present disclosure. In the present embodiment, the communication control process includes an initialization process S100 and a setting process of a RADIUS reauthentication interval S200. The initialization process S100 is a process for setting various conditions required for RADIUS reauthentication at the access point 3. The setting process of the RADIUS reauthentication interval S200 is a process for setting the RADIUS reauthentication interval according to the result of the RADIUS reauthentication in a predetermined period. When the communication control process is started, the control unit 50 first executes the initialization process S100.

### 11. Initialization Process

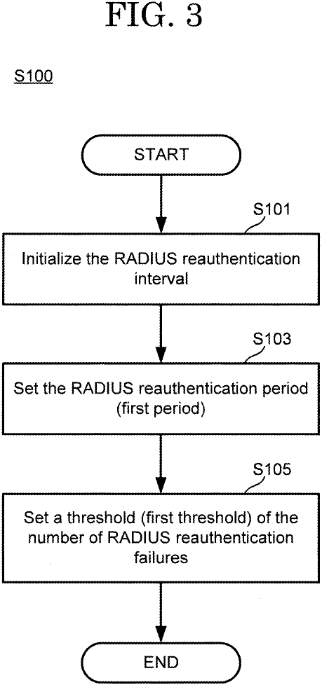

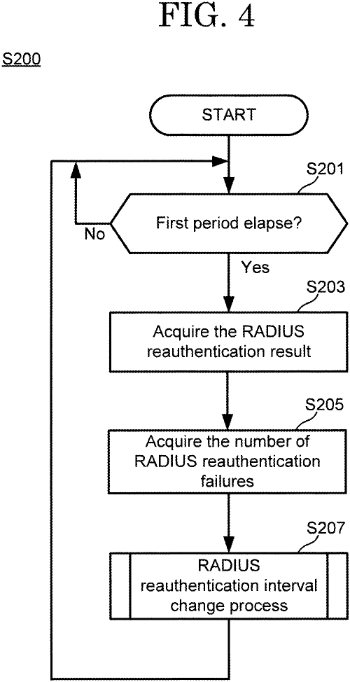

FIG. 3 is a flowchart showing an initialization process. As shown in FIG. 3, when the initialization process S100 is started, the control unit 50 performs a RADIUS reauthentication initialization process on the communication module Ma10 (step S101). In the RADIUS reauthentication initialization process, a time interval (also referred to as a RADIUS reauthentication interval) is set as an initial condition. The RADIUS reauthentication interval to be set may be a predetermined reauthentication interval, a reauthentication interval that has been set at the last power off or may be determined according to a history of the past. The RADIUS reauthentication interval is stored in the memory unit 70. In this example, the control unit 50 sets the RADIUS reauthentication interval to “1 hour”.

Next, the control unit 50 sets a period (also referred to as a first period) during which the RADIUS reauthentication for determining the change of the RADIUS reauthentication interval is performed (S103). The first period to be set may be predetermined, may be a condition that has been set at the last power off, or may be determined according to a history of the past. The set first period is stored in the memory unit 70. In this example, the control unit 50 sets the first period as “8 hours”.

Next, the control unit 50 sets a threshold (also referred to as a first threshold) of the number of RADIUS reauthentication failures for determining the change of the RADIUS reauthentication interval (S105). In this example, “4 times” is set as the first threshold according to “8 hours” of the first period.

When the process (S105) for setting the first threshold ends, the control unit 50 starts the setting process of the RADIUS reauthentication interval S200 to be used based on the number of currently connected communication terminals.

### 12. Setting Process of Radius Reauthentication Interval

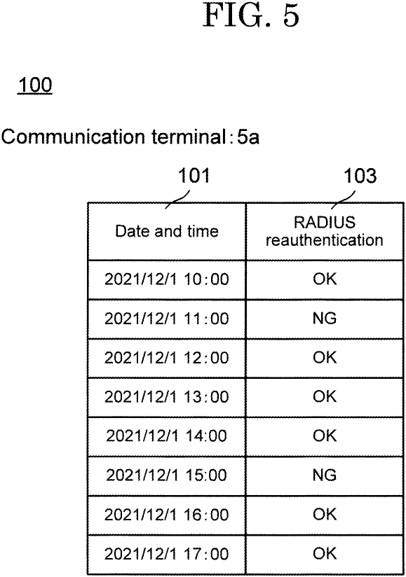

In the setting process of the RADIUS reauthentication interval S200, first, the control unit 50 waits until a predetermined period (first period) elapses (S201; No). When the first period elapses (S201; Yes), the control unit 50 acquires the RADIUS reauthentication result (also referred to as a RADIUS reauthentication failure log) in the first period (S203). FIG. 5 is a RADIUS reauthentication result data table 100 showing the RADIUS reauthentication result in the communication terminal 5a. The RADIUS reauthentication result data table 100 includes date and time information 101 and a RADIUS authentication result 103 corresponding to the date and time information. In this example, the RADIUS authentication is performed every hour with a predetermined period set to “8 hours”. The acquired RADIUS reauthentication result is stored in the memory unit 70.

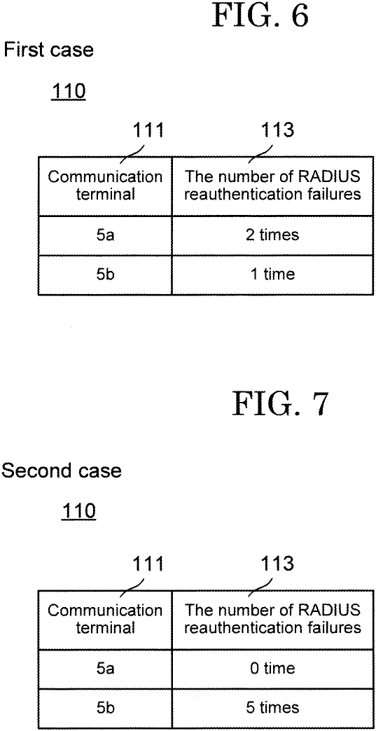

Next, the control unit 50 acquires the number of RADIUS reauthentication failures based on the acquired RADIUS reauthentication result (S205). The number of RADIUS reauthentication failures is the total number of times that the RADIUS reauthentication fails for each of the above-described RADIUS reauthentications during the first period. FIG. 6 and FIG. 7 are data tables 110 of the number of RADIUS reauthentication failures. The data table 110 of the number of RADIUS reauthentication failures includes a communication terminal name 111 and a number of RADIUS reauthentication failures 113. As shown in FIG. 6, in the first case, the number of RADIUS reauthentication failures in the communication terminal 5a is “2 times”, and the number of RADIUS reauthentication failures in the communication terminal 5b is “1 time”. As shown in FIG. 7, in the second case, the number of RADIUS reauthentication failures in the communication terminal 5a is “0 times”, and the number of RADIUS reauthentication failures in the communication terminal 5b is “5 times”.

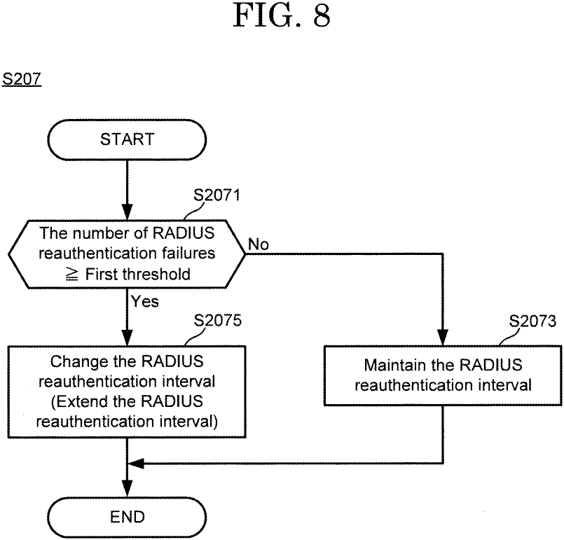

Next, the control unit 50 performs a RADIUS reauthentication interval change process (S207). FIG. 8 is an example of a flowchart showing the RADIUS reauthentication interval change process. As shown in FIG. 8, the control unit 50 determines whether the acquired number of RADIUS reauthentication failures is greater than the threshold (S2071). In this example, the control unit 50 makes a determination using the maximum value among the acquired number of RADIUS reauthentication failures.

For example, in the first case shown in FIG. 6, the maximum value of the number of RADIUS reauthentication failures is “2 times”. In this case, the control unit 50 determines that the number of RADIUS reauthentication failures is smaller than the threshold “4 times” (S2071; No). The control unit 50 maintains the RADIUS reauthentication interval (S2073). Therefore, the RADIUS reauthentication interval is maintained at “1 hour”.

On the other hand, in the second case shown in FIG. 7, the maximum value of the number of RADIUS reauthentication failures is “5”. In this case, the control unit 50 determines that the number of RADIUS reauthentication failures is greater than the threshold “4 times” (S2071; Yes). The control unit 50 changes the RADIUS reauthentication interval so as to be extended (S2075). Specifically, the RADIUS reauthentication interval is changed from “1 hour” to “12 hours”. The control unit 50 repeats the number of communication modules change process S200 when the power is on.

The above-described communication control process is terminated when the power is turned off or switched to another communication control process at the access point 3.

As described above, in the present embodiment, when the number of RADIUS reauthentication failures is small, stable network communication is performed and a network-security environment is maintained. In addition, if the number of RADIUS reauthentication failures is large, it is possible to suppress the occurrence of network communication troubles by increasing the RADIUS reauthentication interval. Therefore, by using the present embodiment, the user does not need to know the wireless environment used by the user himself/herself and it is possible to easily set an appropriate RADIUS reauthentication interval to perform wireless communication.

### Second Embodiment

In the present embodiment, a setting process of the RADIUS reauthentication interval that is different from the first embodiment will be described. Specifically, an example of notifying warning information to the communication terminal after performing the RADIUS reauthentication interval change process will be described. Also, descriptions of portions common to those of the first embodiment will be omitted as appropriate.

### 2-1. Changing Process of Number of Communication Modules

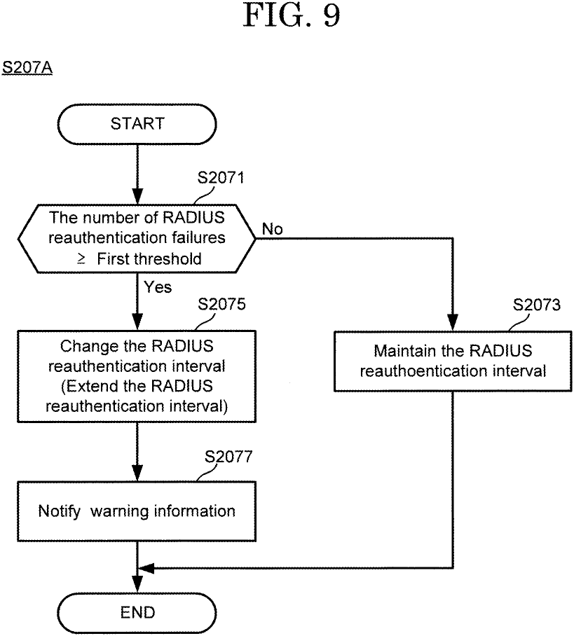

FIG. 9 is an example of a flowchart showing a RADIUS reauthentication interval change process S207A. As shown in FIG. 9, when the control unit 50 determines that the number of RADIUS reauthentication failures is greater than the threshold (S2071; Yes), the control unit 50 changes the RADIUS reauthentication interval to be extended (S2075). In this case, the control unit 50 notifies the network administrator of the warning information indicating that the number of RADIUS reauthentication failures exceeds the threshold (S2077). For example, in the second case, warning information indicating that the number of RADIUS reauthentication failures in the communication terminal 5b is greater than the first threshold is notified to the access point 3. In this case, the warning information may be displayed on a Web GUI (Graphical User Interface) of the access point, a lighting unit may flash, and a mail may be sent from the access point or may be notified to an external control server or the like. Also, the warning information may be displayed on a display unit of the communication terminal 5b, may be displayed as audio information, or may be notified each time the lighting unit of the communication terminal 5b flashes. Also, the warning information notified to the communication terminal 5b may also be sent to the communication terminal 5a. As a result, it becomes clear in which communication terminal the error is occurring, an appropriate RADIUS reauthentication interval can be easily set, and a stable network environment can be established.

### Third Embodiment

In the present embodiment, a communication system that is different from the first embodiment will be described. Specifically, an example of shortening the RADIUS reauthentication interval when a state in which the number of RADIUS reauthentication failures is less than the second threshold that is less than the first threshold in a predetermined period (first period) continues for a period longer than the first period (also referred to as a second period) will be described. Also, descriptions of portions common to those of the first embodiment will be omitted as appropriate.

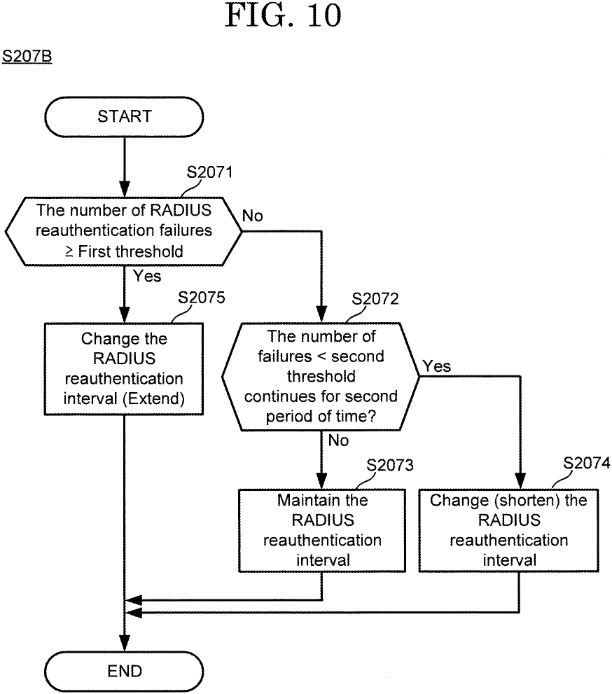

FIG. 10 is an example of a flowchart showing a RADIUS reauthentication interval change process S207B. As shown in FIG. 10, when the control unit 50 determines that the number of RADIUS reauthentication failures is greater than the first threshold (four times) (S2071; Yes), the control unit 50 changes the RADIUS reauthentication interval to be extended (S2075). When it is determined that the number of RADIUS reauthentication failures is less than the first threshold (4 times) (S2071; No), it may be further determined whether a state in which the number of RADIUS reauthentication failures is less than the second threshold which is less than the first threshold continues for a predetermined period (second period) longer than the first period (S2072). For example, the second threshold of the number of RADIUS reauthentication failures may be set to “1 time” and the second time period may be set to “1 week” when the first period is “8 hours (1 day)” and the RADIUS reauthentication interval is “1 hour”. If the above condition is not satisfied (S2072; No), the RADIUS reauthentication interval is maintained (S2073). When the above condition is satisfied (S2072; Yes), the control unit 50 may change the RADIUS reauthentication interval to be shortened to “30 minutes” (S2074).

Using the present embodiment makes it possible to control the RADIUS reauthentication interval according to the network environment. In this example, the RADIUS reauthentication interval has strict conditions for shortening than for extending. As a result, it is possible to suppress the occurrence of network connection troubles. In addition, the RADIUS reauthentication interval can be shortened if the RADIUS reauthentication is stable and successful over the long term. As a result, it is possible to easily set an appropriate RADIUS reauthentication interval and to improve the network-security environment.

### Fourth Embodiment

In the present embodiment, an example of performing a RADIUS reauthentication interval setting process S200C based on the time information will be described.

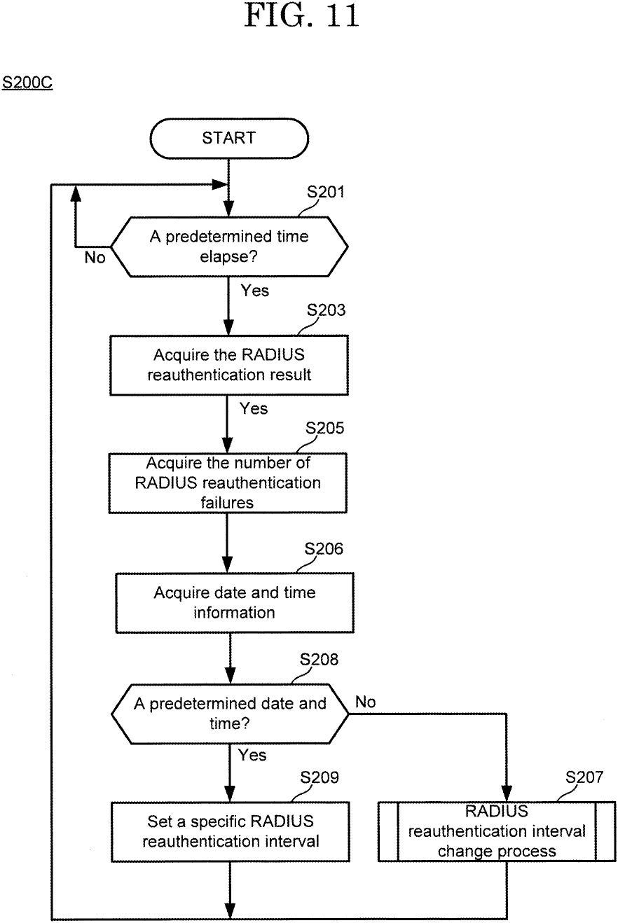

FIG. 11 is an example of a flowchart showing S200C. In the RADIUS reauthentication interval change process S200C, the control unit 50 acquires the number of RADIUS reauthentication failures in each communication terminal in a predetermined period (S205), and then the control unit 50 acquires the date and time information (S206). Also, the timing for acquiring the date and time information is not particularly limited. The date and time information may be acquired from within the access point 3 or may be acquired from another device. The control unit 50 determines whether the acquired date and time information is a predetermined date and time (S208). If the acquired date and time is not the predetermined time (S208; No), the RADIUS reauthentication interval change process is performed (S207). The RADIUS reauthentication interval change process S207 is as described in the first embodiment of the present disclosure.

On the other hand, in the case where the acquired date and time information is the predetermined date and time (S208; Yes), the control unit 50 sets the RADIUS reauthentication interval to a specific interval (S209). The specific RADIUS reauthentication interval may be set based on the number of communication terminals to be connected and the date and time information. Specifically, the RADIUS reauthentication interval may be set to “1 hour” on Saturday and Sunday when the wireless network communication is low.

When the present embodiment is used, a predetermined RADIUS reauthentication interval is set at a predetermined date and time. Therefore, an appropriate RADIUS reauthentication interval can be easily set.

### Fifth Embodiment

In the present embodiment, a configuration of a communication system that is different from the first embodiment will be described. Specifically, an example in which the communication system includes a different access point will be described. Also, descriptions of portions common to those of the first embodiment will be omitted as appropriate.

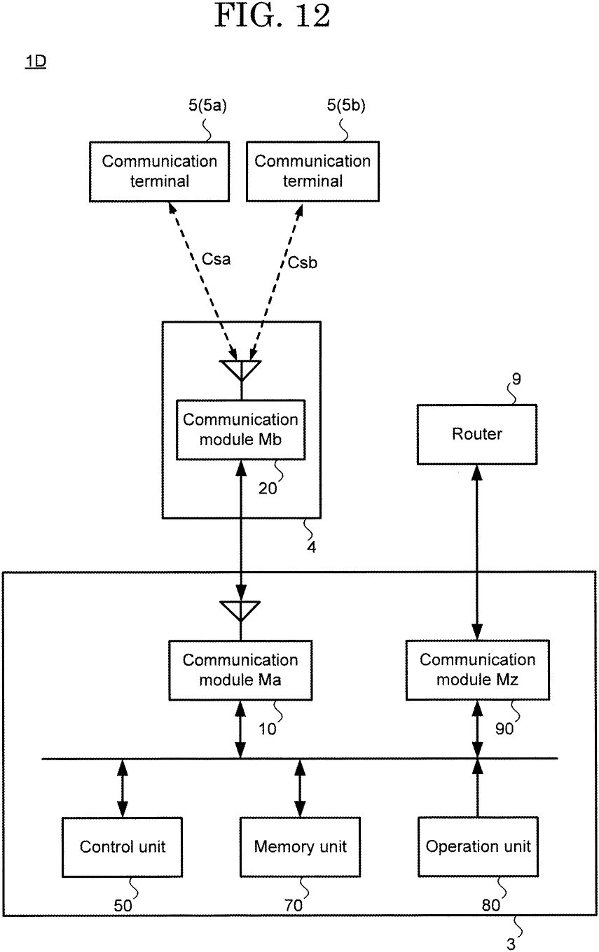

FIG. 12 is a configuration diagram of a communication system 1D. As shown in FIG. 12, the communication system 1D includes an access point 4 in addition to the access point 3, the communication terminal 5, and the router 9. The access point 4 includes a communication module Mb20. The communication module Mb20 may have a configuration similar to that of the communication module Ma10 of the access point 3. The access point 3 and the access point 4 are arranged in the same network segment. As shown in FIG. 12, the access point 3 and the access point 4 may be directly connected or may be connected via the router 9. In the present embodiment, the communication terminal 5 performs wireless communication with the access point 4. In this case, the access point 4 may function as the RADIUS client, and the access point 3 may function as the RADIUS server. The control unit 50 of the access point 3 may perform the communication control process using various information stored at the access point 3 and the access point 4.

### Sixth Embodiment

In the present embodiment, a setting process of a threshold (first threshold) of the number of RADIUS reauthentication failures that is different from the first embodiment will be described. More specifically, an example of acquiring the number of communication terminals to be connected and setting the first threshold is described.

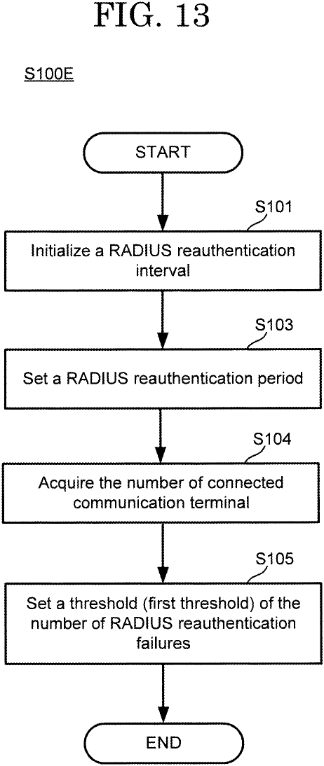

FIG. 13 is a flowchart illustrating an initialization process S100E. As shown in FIG. 13, in the present embodiment, after the RADIUS reauthentication period is set (S103), the control unit 50 may acquire the number of communication terminals to be connected (S104). In this case, the control unit 50 may set a threshold (first threshold) of the number of RADIUS reauthentication failures based on the number of communication terminals to be connected (S105). For example, when the number of communication terminals to be connected is large, the first threshold may be set low. As a result, it is possible to prevent the network connection from being frequently disconnected due to the RADIUS reauthentication failures, and an appropriate RADIUS reauthentication interval can be easily set.

### Modification

While an embodiment of the present disclosure has been described above, within the spirit of the present disclosure, it is understood that various modifications and changes can be made by those skilled in the art and that these modifications and changes also fall within the scope of the present disclosure. For example, the addition, deletion, or design change of components, or the addition, deletion, or condition change of processes as appropriate by those skilled in the art based on each embodiment are also included in the scope of the present disclosure as long as they are provided with the gist of the present invention.

In the first embodiment of the present disclosure, although an example of performing the determination process using the maximum value among the acquired number of RADIUS reauthentication failures is shown, the present disclosure is not limited to this. For example, the determination process may be performed using an average or a median of the acquired number of RADIUS reauthentication failures.

In addition, in the first embodiment of the present disclosure, although an example in which the various information related to the communication control process are stored in the memory unit 70 of the access point 3 is shown, the present disclosure is not limited thereto. The various information may be stored in a memory device of a communication device or a server (a local server or a cloud server) different from the access point 3. In addition, the communication control process is not limited to the control unit 50 of the access point 3 and may be executed by a control unit arranged in another device such as a server.

In the first embodiment of the present disclosure, although an example of using the set first threshold is shown, the present disclosure is not limited thereto. For example, machine learning may be performed using information related to the RADIUS authentication as an input value in advance, and the first threshold may be output using the generated learned model. In this case, the first threshold may vary as appropriate.

In the first embodiment of the present disclosure, although an example in which the access point 3 has the function of the RADIUS server is shown, the present disclosure is not limited thereto. For example, a communication device arranged outside the access point 3 may have the function of the RADIUS server.

In the fourth embodiment of the present disclosure, although an example of setting the specific RADIUS reauthentication interval based on the predetermined specific date and time information is shown, the present disclosure is not limited thereto. For example, machine learning may be performed on the transition data of the RADIUS reauthentication failures, and a specific RADIUS reauthentication interval may be set at a specific date and time (day of the week or time zone) depending on the learning result.

In the wireless communication device according to an embodiment of the present disclosure, the program, when executed, further may cause the processor to: perform RADIUS reauthentication of the first communication terminal at each RADIUS reauthentication interval occurring during a predefined first period of time, and wherein the number of RADIUS reauthentication failures for the first communication terminal is a total number of times that the RADIUS reauthentication fails for the first communication terminal during the predefined first period of time.

In the wireless communication device according to an embodiment of the present disclosure, the program, when executed, further may cause the processor to: shorten the RADIUS reauthentication interval in a case where the number of RADIUS reauthentication failures for the first communication terminal remains less than a second threshold over a second predefined period of time, and wherein the second threshold is less than the first threshold, and the second predefined period of time is longer than the first predefined period of time.

In the wireless communication device according to an embodiment of the present disclosure, the program, when executed, further may cause the processor to: set the first threshold based on a number of communication terminals wirelessly connected to the wireless communication device.

In the wireless communication device according to an embodiment of the present disclosure, the program, when executed, further may cause the processor to: acquire date and time information; and set the RADIUS reauthentication interval to a predetermined time interval in a case where the date and time information satisfies a predetermined condition.

In the wireless communication device according to an embodiment of the present disclosure, the program, when executed, further may cause the processor to: provide, in a case where the number of RADIUS reauthentication failures in at least one communication terminal among the plurality of communication terminals is greater than the first threshold, a notification indicating that the number of RADIUS reauthentication failures in the at least one communication terminal is greater than the first threshold.

In the wireless communication device according to an embodiment of the present disclosure, the program, when executed, further may cause the processor to: perform RADIUS reauthentication of the first communication terminal at each RADIUS reauthentication interval occurring during a period of time, extend the RADIUS reauthentication interval in a case where the number of RADIUS reauthentication failures for the first communication terminal exceeds the first threshold over a first period of time; and shorten the RADIUS reauthentication interval in a case where the number of RADIUS reauthentication failures for the first communication terminal remains less than a second threshold over a second period of time, and wherein the second threshold is less than the first threshold, and the second period of time is longer than the first period of time.

In the wireless communication device according to an embodiment of the present disclosure, the program, when executed, further may cause the processor to: perform RADIUS reauthentication of the first communication terminal at each RADIUS reauthentication interval occurring during a period of time; and extend the RADIUS reauthentication interval in a case where the number of RADIUS reauthentication failures for the first communication terminal exceeds the first threshold over the period of time.

The communication control method according to an embodiment of the present disclosure may include performing RADIUS reauthentication of the first communication terminal at each RADIUS reauthentication interval occurring during a predefined first period of time, wherein the number of RADIUS reauthentication failures for the first communication terminal is a total number of times that the RADIUS reauthentication fails for the first communication terminal during the predefined first period of time.

The communication control method according to an embodiment of the present disclosure may include shortening the RADIUS reauthentication interval in a case where the number of RADIUS reauthentication failures for the first communication terminal remains less than a second threshold over a second predefined period of time, wherein the second threshold is less than the first threshold, and the second predefined period of time is longer than the first predefined period of time.

The communication control method according to an embodiment of the present disclosure may include setting the first threshold based on a number of communication terminals wirelessly connected to the wireless communication device.

The communication control method according to an embodiment of the present disclosure may include acquiring date and time information; and setting the RADIUS reauthentication interval to a predetermined time interval in a case where the date and time information satisfies a predetermined condition.

The communication control method according to an embodiment of the present disclosure may include providing, in a case where the number of RADIUS reauthentication failures in at least one communication terminal among the plurality of communication terminals is greater than the first threshold, a notification indicating that the number of RADIUS reauthentication failures in the at least one communication terminal is greater than the first threshold.

The communication control method according to an embodiment of the present disclosure may include performing RADIUS reauthentication of the first communication terminal at each RADIUS reauthentication interval occurring during a period of time; extending the RADIUS reauthentication interval in a case where the number of RADIUS reauthentication failures for the first communication terminal exceeds the first threshold over a first period of time; and shortening the RADIUS reauthentication interval in a case where the number of RADIUS reauthentication failures for the first communication terminal remains less than a second threshold over a second period of time, wherein the second threshold is less than the first threshold, and the second period of time is longer than the first period of time.

The communication control method according to an embodiment of the present disclosure may include performing RADIUS reauthentication of the first communication terminal at each RADIUS reauthentication interval occurring during a period of time; and extending the RADIUS reauthentication interval in a case where the number of RADIUS reauthentication failures for the first communication terminal exceeds the first threshold over the period of time.

What is claimed is:

1. A wireless communication device, comprising:
a processor; and
a memory configured to store a program, the program being executable by the processor to cause the processor to:
change a Remote Authentication Dial-in User Service (RADIUS) reauthentication interval used by the wireless communication device functioning as a RADIUS server based on:
(i) a number of RADIUS reauthentication failures for a first communication terminal among a plurality of communication terminals connected to the wireless communication device, and
(ii) a first threshold.

2. The wireless communication device according to claim 1, wherein the program, when executed, further causes the processor to:
perform RADIUS reauthentication of the first communication terminal at each RADIUS reauthentication interval occurring during a predefined first period of time, and
wherein the number of RADIUS reauthentication failures for the first communication terminal is a total number of times that the RADIUS reauthentication fails for the first communication terminal during the predefined first period of time.

3. The wireless communication device according to claim 2, wherein the program, when executed, further causes the processor to:
shorten the RADIUS reauthentication interval in a case where the number of RADIUS reauthentication failures for the first communication terminal remains less than a second threshold over a second predefined period of time, and
wherein the second threshold is less than the first threshold, and the second predefined period of time is longer than the first predefined period of time.

4. The wireless communication device according to claim 1, wherein the program, when executed, further causes the processor to:
set the first threshold based on a number of communication terminals wirelessly connected to the wireless communication device.

5. The wireless communication device according to claim 1, wherein the program, when executed, further causes the processor to:
acquire date and time information; and
set the RADIUS reauthentication interval to a predetermined time interval in a case where the date and time information satisfies a predetermined condition.

6. The wireless communication device according to claim 1, wherein the program, when executed, further causes the processor to:
provide, in a case where the number of RADIUS reauthentication failures in at least one communication terminal among the plurality of communication terminals is greater than the first threshold, a notification indicating that the number of RADIUS reauthentication failures in the at least one communication terminal is greater than the first threshold.

7. The wireless communication device according to claim 1, wherein the program, when executed, further causes the processor to:
perform RADIUS reauthentication of the first communication terminal at each RADIUS reauthentication interval occurring during a period of time, extend the RADIUS reauthentication interval in a case where the number of RADIUS reauthentication failures for the first communication terminal exceeds the first threshold over a first period of time; and
shorten the RADIUS reauthentication interval in a case where the number of RADIUS reauthentication failures for the first communication terminal remains less than a second threshold over a second period of time, and
wherein the second threshold is less than the first threshold, and the second period of time is longer than the first period of time.

8. The wireless communication device according to claim 1, wherein the program, when executed, further causes the processor to:
perform RADIUS reauthentication of the first communication terminal at each RADIUS reauthentication interval occurring during a period of time; and
extend the RADIUS reauthentication interval in a case where the number of RADIUS reauthentication failures for the first communication terminal exceeds the first threshold over the period of time.

9. A communication control method performed by a wireless communication device, the communication control method comprising: changing a Remote Authentication Dial-in User Service (RADIUS) reauthentication interval used by the wireless communication device functioning as a RADIUS server based on:
(i) a number of RADIUS reauthentication failures for a first communication terminal among a plurality of communication terminals connected to the wireless communication device, and
(ii) a first threshold.

10. The communication control method according to claim 9, further comprising:
performing RADIUS reauthentication of the first communication terminal at each RADIUS reauthentication interval occurring during a predefined first period of time,
wherein the number of RADIUS reauthentication failures for the first communication terminal is a total number of times that the RADIUS reauthentication fails for the first communication terminal during the predefined first period of time.

11. The communication control method according to claim 10, further comprising:
shortening the RADIUS reauthentication interval in a case where the number of RADIUS reauthentication failures for the first communication terminal remains less than a second threshold over a second predefined period of time,
wherein the second threshold is less than the first threshold, and the second predefined period of time is longer than the first predefined period of time.

12. The communication control method according to claim 9, further comprising:
setting the first threshold based on a number of communication terminals wirelessly connected to the wireless communication device.

13. The communication control method according to claim 9, further comprising:
acquiring date and time information; and
setting the RADIUS reauthentication interval to a predetermined time interval in a case where the date and time information satisfies a predetermined condition.

14. The communication control method according to claim 9, further comprising:
providing, in a case where the number of RADIUS reauthentication failures in at least one communication terminal among the plurality of communication terminals is greater than the first threshold, a notification indicating that the number of RADIUS reauthentication failures in the at least one communication terminal is greater than the first threshold.

15. The communication control method according to claim 9, further comprising:
performing RADIUS reauthentication of the first communication terminal at each RADIUS reauthentication interval occurring during a period of time;
extending the RADIUS reauthentication interval in a case where the number of RADIUS reauthentication failures for the first communication terminal exceeds the first threshold over a first period of time; and
shortening the RADIUS reauthentication interval in a case where the number of RADIUS reauthentication failures for the first communication terminal remains less than a second threshold over a second period of time,
wherein the second threshold is less than the first threshold, and the second period of time is longer than the first period of time.

16. The communication control method according to claim 9, further comprising:
performing RADIUS reauthentication of the first communication terminal at each RADIUS reauthentication interval occurring during a period of time; and
extending the RADIUS reauthentication interval in a case where the number of RADIUS reauthentication failures for the first communication terminal exceeds the first threshold over the period of time.

17. A non-transitory computer readable storage medium storing a program for causing a computer to:
change a Remote Authentication Dial-in User Service (RADIUS) reauthentication interval used by a wireless communication device functioning as a RADIUS server based on:
(i) a number of RADIUS reauthentication failures for a first communication terminal among a plurality of communication terminals connected to the wireless communication device, and
(ii) a first threshold.
